(19) United States
(12) Patent Application Publication
(10) Pub. No.: US 2026/0187466 A1
(43) Pub. Date: Jul. 2, 2026

(54) SYSTEM AND METHOD FOR GENERATING LLM PROMPTS WITH CONTEXT BASED ON RESPONSES FROM MULTIPLE LLMS

(71) Applicants: Constructor Technology AG, Schaffhausen (CH); Constructor Education and Research Genossenschaft, Schaffhausen (CH)

(72) Inventors: Andrey ADASHCHIK, Istanbul (TR); Alexander TORMASOV, Busingen am Hochrhein (DE); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/004,152

(22) Filed: Dec. 27, 2024

(51) Int. Cl. G06N 3/0895; G06F 3/0482; G06F 40/30

(52) U.S. Cl. CPC G06N 3/0895; G06F 40/30; G06F 3/0482

(57) ABSTRACT

Disclosed herein are systems and methods for generating a prompt with context based on a list of topics generated for responses from large language models (LLMs). In one aspect, the method includes: obtaining a query from a user; generating and transmitting a prompt based on the query for input into a first and second LLMs; obtaining a first selected portion of the first response from the first LLM and at least a second selected portion of the second response from the second LLM; generating a list of topics using a trained topic analysis machine learning model (MLM) to identify topics from the responses; and generating a prompt for input into the third LLM utilizing at least one topic from the list of topics using at least the selected portions from the first LLM or the selected portions from the second LLM.

### FIELD OF TECHNOLOGY

The present disclosure relates to the field of large language models (LLMs), and, more specifically, to systems and methods for generating LLM prompts.

### BACKGROUND

Users may wish to harness the power of machine learning models (MLM) such as utilizing a large language model (LLM) for a variety of tasks. LLMs may be used for a variety of tasks such as topic modeling, text classification, data cleansing, data labeling. In particular a LLM may understand and generate natural language text based on understanding prompts from a user. LLMs work by attempting to understand the prompt from the user and then outputting strings of words that the LLM predicts will best answer the prompt based on the data it was trained on. In some situations, a LLM may provide responses without context, which can have several drawbacks that may impact their usefulness and accuracy. Without context, responses may be vague or open to multiple interpretations. For example, a lack of context can lead to irrelevant answers or inappropriate application of knowledge as a LLM may not understand a specific circumstance. As another example, users may need to ask follow-up questions or provide additional context themselves making the interaction longer and less efficient. Therefore, there is a need for an improved user interface to provide context for a prompt by utilizing a list of topics generated from responses.

### SUMMARY

To address the shortcoming of unsatisfactory responses from LLMS, the present disclosure describes implementing a user interface that improves responses by providing context for a subsequent prompt using a list of topics generated from the response from different LLMS. Some of the technical improvements of the present disclosure are to eliminate multiple separate user interfaces for separate LLMs and improve response from LLMs by directing the subsequent prompt toward topics that the user is interested in. In particular, the present disclosure provides a user interface that is configured to display responses from different LLMs trained on different topics (e. g, subject matter) and generate a list of topics based on the responses from the different LLMs. In addition, the present disclosure describes generating a new prompt with context based on user selected portions of the LLM responses to combine with the topics from the generated list of topics.

In one exemplary aspect, a method for generating a prompt with context based on a topic list generated from responses from LLMs is disclosed, the method comprising: implementing a UI configured to combine and select feedback from at least a first LLM and a second LLM into a new prompt for input into a third LLM, wherein the first LLM is different from the second LLM; obtaining a query from a user from an input portion of the UI; generating and transmitting a prompt based on the query for input into the first LLM and a second LLM; obtaining a first response from the first LLM and a second response from the second LLM; obtaining, from the user, at least a first selected portion of the first response from the first LLM and at least a second selected portion of the second response from the second LLM; generating a list of topics from at least the obtained first selected portion of the first response from the first LLM and the second selected portion of the second response from the second LLM using a trained topic analysis machine learning model (MLM) prepared to identify topics from responses of LLMs; and generating the new prompt for input into the third LLM, the new prompt comprising at least one topic from the list of topics using at least the selected portions from the first LLM or the selected portions from the second LLM.

In some aspects, the techniques described herein relate to a method, wherein generating the new prompt for input into the third LLM further comprises: obtaining a selection of topics from the list of topics to include into the new prompt for the third LLM.

In some aspects, the techniques described herein relate to a method, wherein at least one portion from the first response from the first LLM and the at least one portion from the second response from the second LLM are marked for using as a basis for a respective topics from the list of topics to include into the new prompt for the third LLM.

In some aspects, the techniques described herein relate to a method, wherein generating the new prompt for input into the third LLM further comprises: obtaining a selection of particular topics from the list of topics to exclude in the new prompt for the third LLM.

In some aspects, the techniques described herein relate to a method, the method further comprising: transmitting the new prompt into the third LLM; and obtaining and displaying a new response from the third LLM.

In some aspects, the techniques described herein relate to a method, the method further comprising preparing the topic analysis MLM based on utilizing a text interpretation large language model to identify different subject matter or topics from the responses of the LLMs.

In some aspects, the techniques described herein relate to a method, the method further comprising transmitting the new prompt into the first LLM or the second LLM; obtaining at least an updated first response from the first LLM or an updated second response from the second LLM; and displaying the query along with the updated first response from the first LLM in the first portion of the UI and the updated second response from the second LLM in the second portion of the UI.

In some aspects, the techniques described herein relate to a method, the method further comprising displaying, in the UI, a supplemental UI comprising a menu of text editing functions for editing the query, the first response or the new response.

In some aspects, the techniques described herein relate to a method, the method further comprising displaying, in the UI, a first graphical element configured to mark a response as important, not important, or to be deleted.

In some aspects, the techniques described herein relate to a method, the method further comprising displaying, in the UI, a drop down graphical element with options including at least: a first option to edit the query, a second option to save the query, a third option to mark a portion of the first response or the new response as important, a fourth option to mark a portion of the first response or the new response as unimportant, a fifth option to mark a portion of the first response or the new response as to be deleted, or a sixth option to edit the first response from the first LLM or the second response from the second LLM.

According to one aspect of the disclosure, a system is provided for generating a prompt with context based on a topic list generated from responses from LLMs, the system comprising at least one memory; and at least one hardware processor coupled with the at least one memory and configured, individually or in combination to: implement a UI configured to combine and select feedback from at least a first LLM and a second LLM into a new prompt for input into a third LLM, wherein the first LLM is different from the second LLM; obtain a query from a user from an input portion of the UI; generate and transmit a prompt based on the query for input into the first LLM and a second LLM; obtain a first response from the first LLM and a second response from the second LLM; obtain, from the user, at least a first selected portion of the first response from the first LLM and at least a second selected portion of the second response from the second LLM; generate a list of topics from at least the obtained first selected portion of the first response from the first LLM and the second selected portion of the second response from the second LLM using a trained topic analysis machine learning model (MLM) prepared to identify topics from responses of LLMs; and generate the new prompt for input into the third LLM, the new prompt comprising at least one topic from the list of topics using at least the selected portions from the first LLM or the selected portions from the second LLM.

In one exemplary aspect, a non-transitory computer-readable medium is provided storing a set of instructions thereon for generating a prompt with context based on a topic list generated from responses from LLMs, wherein the set of instructions comprises instructions for:
implementing a UI configured to combine and select feedback from at least a first LLM and a second LLM into a new prompt for input into a third LLM, wherein the first LLM is different from the second LLM; obtaining a query from a user from an input portion of the UI; generating and transmitting a prompt based on the query for input into the first LLM and a second LLM; obtaining a first response from the first LLM and a second response from the second LLM; obtaining, from the user, at least a first selected portion of the first response from the first LLM and at least a second selected portion of the second response from the second LLM; generating a list of topics from at least the obtained first selected portion of the first response from the first LLM and the second selected portion of the second response from the second LLM using a trained topic analysis machine learning model (MLM) prepared to identify topics from responses of LLMs; and generating the new prompt for input into the third LLM, the new prompt comprising at least one topic from the list of topics using at least the selected portions from the first LLM or the selected portions from the second LLM.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for providing a user interface (UI) to improve responses from large language models (LLMs) according to aspects of the present disclosure.

FIGS. 2A-2F are diagrams illustrating a method for generating a prompt with context by generating a topic list from previous responses from LLMs according to aspects of the present disclosure.

FIG. 3 is an example method for selecting portions of a response from separate LLM to use as context for generating a new prompt with context according to an aspect of the present disclosure.

FIG. 4 is an example method for generating a new prompt with context according to a generated list of topics according to an aspect of the present disclosure.

FIG. 5 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for generating a new prompt with context by generating a topic list based on responses from different LLMs. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Different LLMs may provide different responses to a same prompt due to a complex interplay of factors, including training data, model architecture, training objectives, inference techniques, preprocessing steps, and/or prompt design. First, different LLMs are trained on different datasets, which can vary in size, diversity, and quality. For example, a particular model may be trained on a dataset that includes more scientific literature, while another might have more conversational data. In addition, training data may introduce biases that affect a particular model's responses. As an example, if a model's dataset has more examples of a particular type of language or viewpoint, then that difference will be reflected in its response. Second, different LLMs may have different architectures. For example, GPT-3 and BERT are both transformer-based models but are designed for different tasks and have different internal structures. Third, training objectives between the LLMS may be different. For example, some models may be fine-tuned for specific tasks, such as question answering, summarization, or translation. Fourth the different LLMS may have different inference techniques. As a non-limiting example, the methods used to generate text during inference may vary such the same query will produce different responses from different models.

Accordingly, users are often forced to choose between using a single LLM at a time since each LLM generally has their own interface and/or application for the user to interact with the LLM. Some platforms provide web-based interfaces where users may directly interact with LLMS by typing in prompts and receiving responses. APIs may also allow developers to integrate LLM capabilities into their own applications.

The present disclosure describes various aspects of providing a user interface (UI) to improve responses from multiple LLMs by generating a prompt with context from multiple LLMs to a subsequent LLM. One aspect involves generating a list of topics from responses of different LLM. Another aspect involves selecting interested topics from the list of topics for inclusion into a new prompt. Yet another aspect involves creating the new prompt for input into a third LLM by adding context from the selected interested topics, excluding topics from the list of topics, or including all of the topics on the list of topics.

A main benefit of the present disclosure is knowledge aggregation by combining inputs from two LLMs to help aggregate knowledge and leverage broader datasets and error propagation control by carefully selecting only accurate and relevant portions from the first two LLM responses such that error propagation to the third LLM can be minimized. For example, a user may leverage selected portions from a first or second LLM that allows a third LLM to process highly relevant and contextualized information. The ability to select portions of a response from a particular LLM and a list of topics to be included in a new prompt ensures that only relevant information related to the topic is forwarded, which avoids the inclusion of extraneous or irrelevant content. In this way, the third LLM generates responses that are on-point, concise, and tailored to the specific topic.

In addition, the present disclosure also describes various aspects of generating a list of topics from responses of different LLMs may provide an enhanced perspective as different LLMs may emphasize various aspects of a query based on their training, architecture, or contextual understanding. By aggregating topics from multiple LLM responses, the present disclosure allows users to gain a broader and more diverse set of insights. As another example, if one LLM produces incomplete or partially flawed responses, inputting a curated selection with a list of topics to be addressed into a third LLM allows the third LLM to refine, correct, or expand upon the initial context. In addition, combining ideas or elements from multiple LLMs introduces variety and creative synthesis, which the third LLM can use to generate novel insights based on topic-specific fine tuning. Furthermore, pre-curating relevant content narrows the scope of information the third LML must process, leading to faster and more focused response generation, which saves computational resources and reduces latency in producing high-quality outputs. Accordingly, the present disclosure enhances the specificity and appropriateness of the generated response by grounding them in pre-filtered, topic-specific data. Furthermore, using multiple LLMs in tandem capitalizes on their unique strengths such as specific training datasets or optimization focuses.

Turning now to the figures, example aspects are depicted with reference to one or more components described herein, where components in dashed lines may be optional.

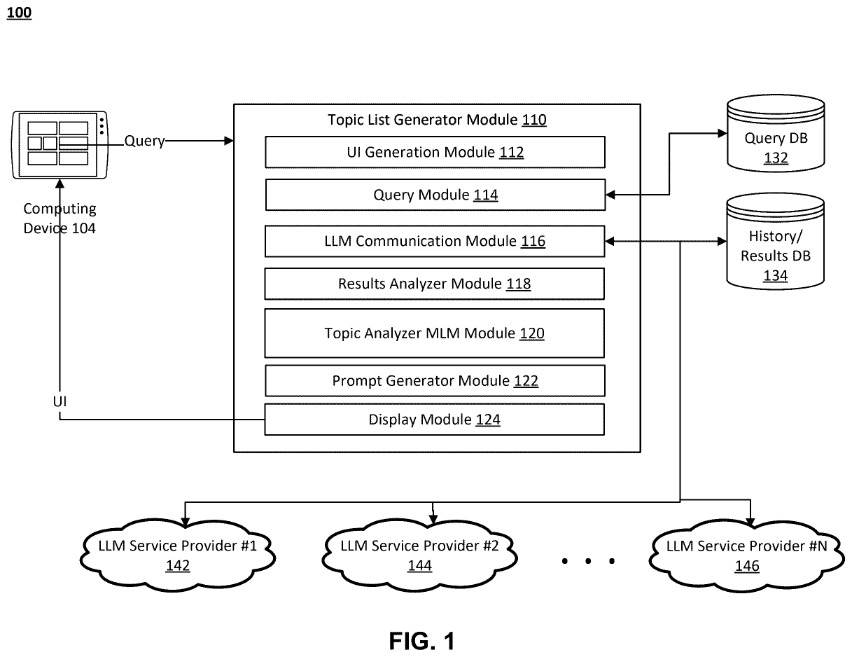

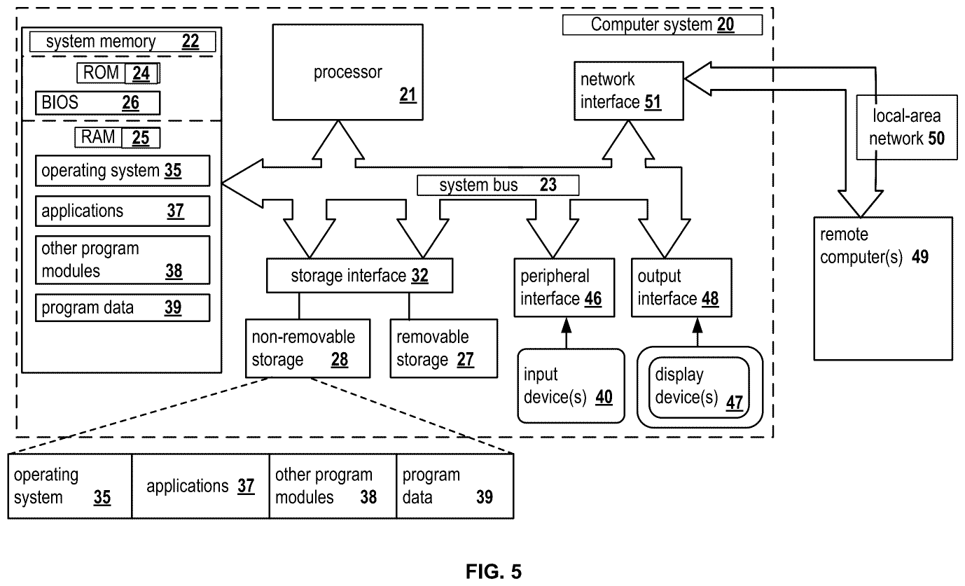

FIG. 1 is a block diagram illustrating a system 100 configured to provide a UI to improve responses from different LLMs by generating a prompt with context from a generated list of topics. In one aspect, the components of system 100 may be implemented on computer systems, such as that shown in FIG. 5.

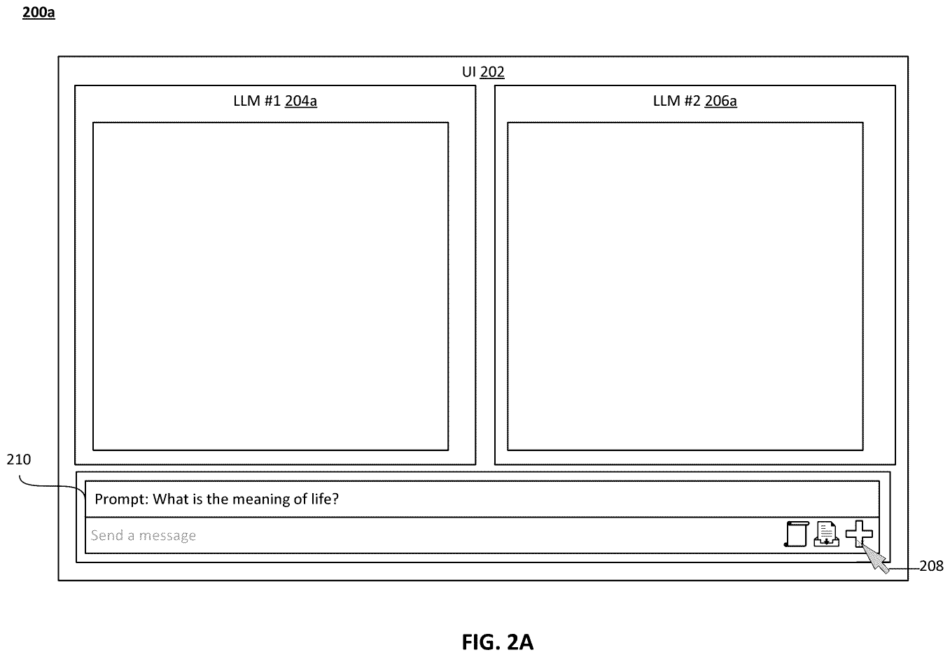

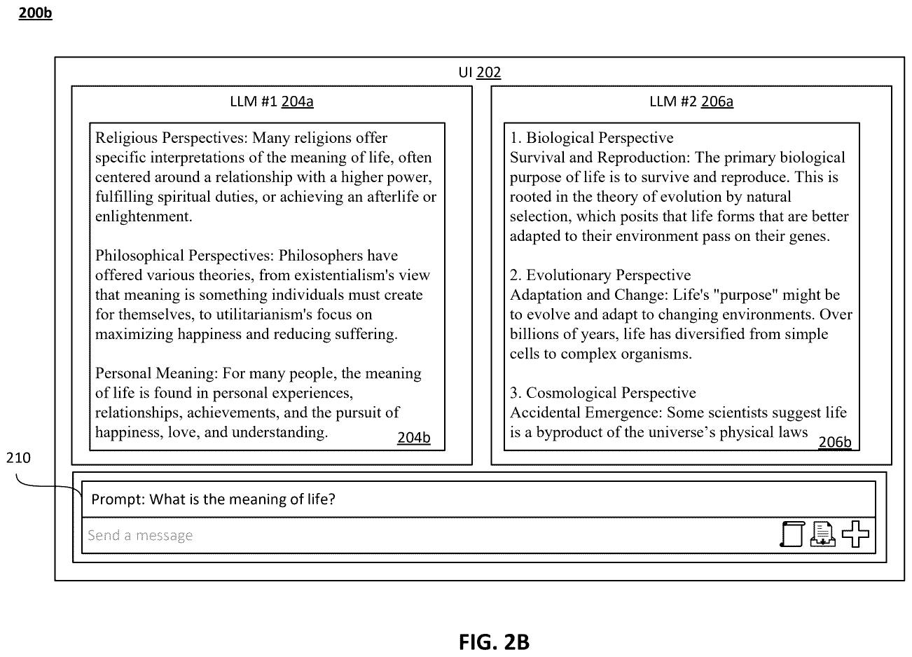

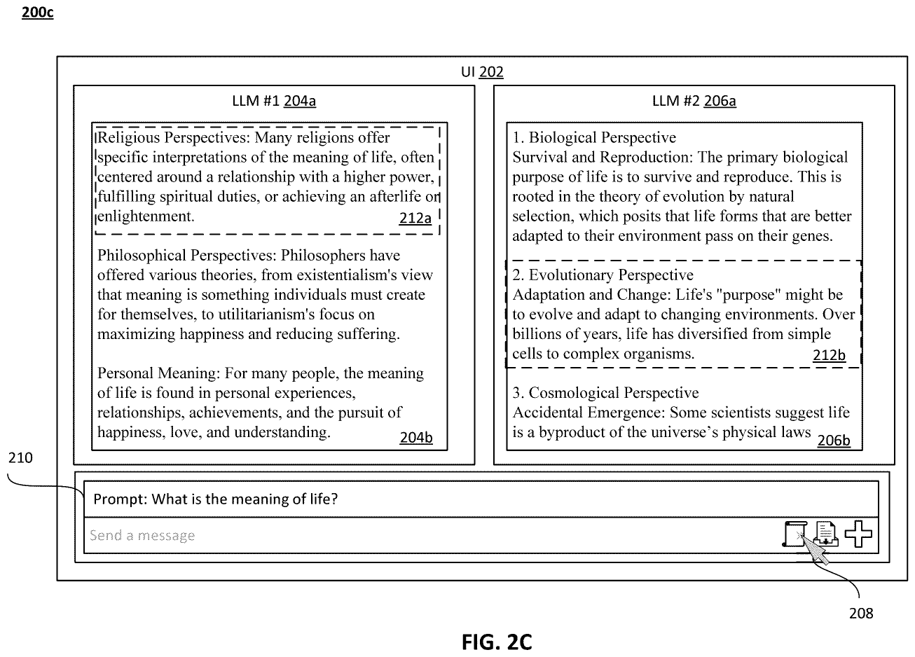

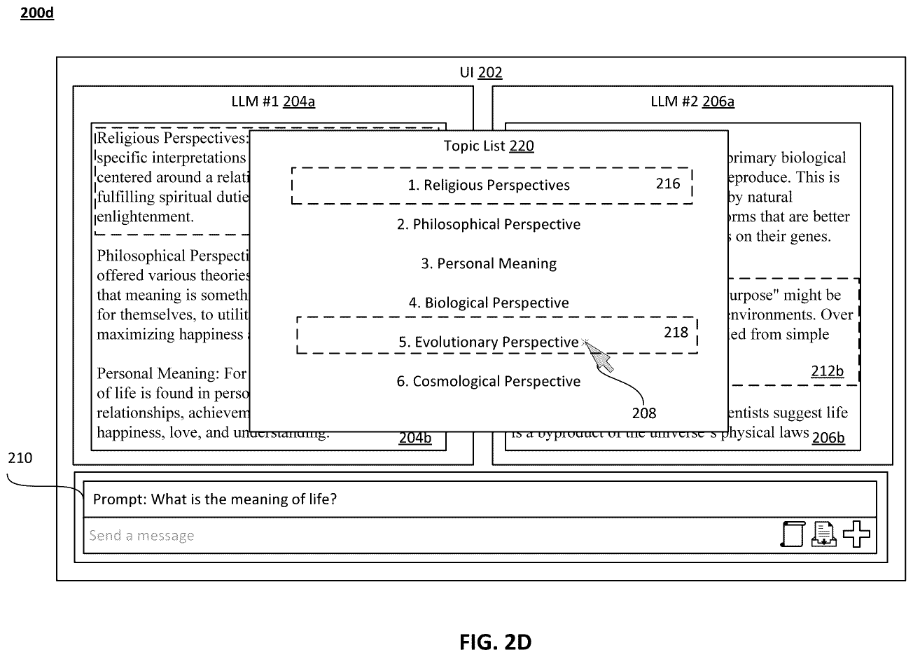

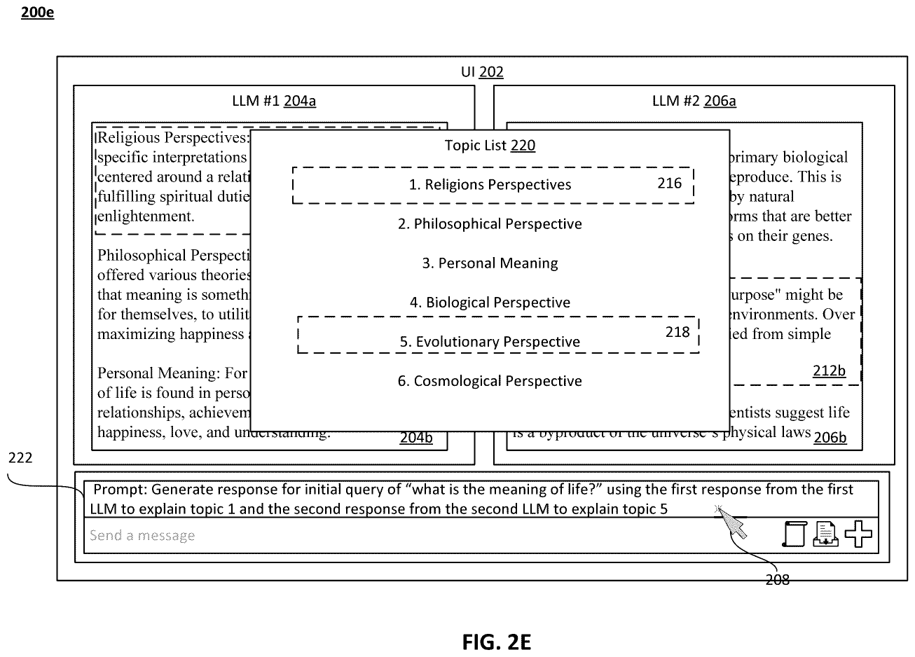

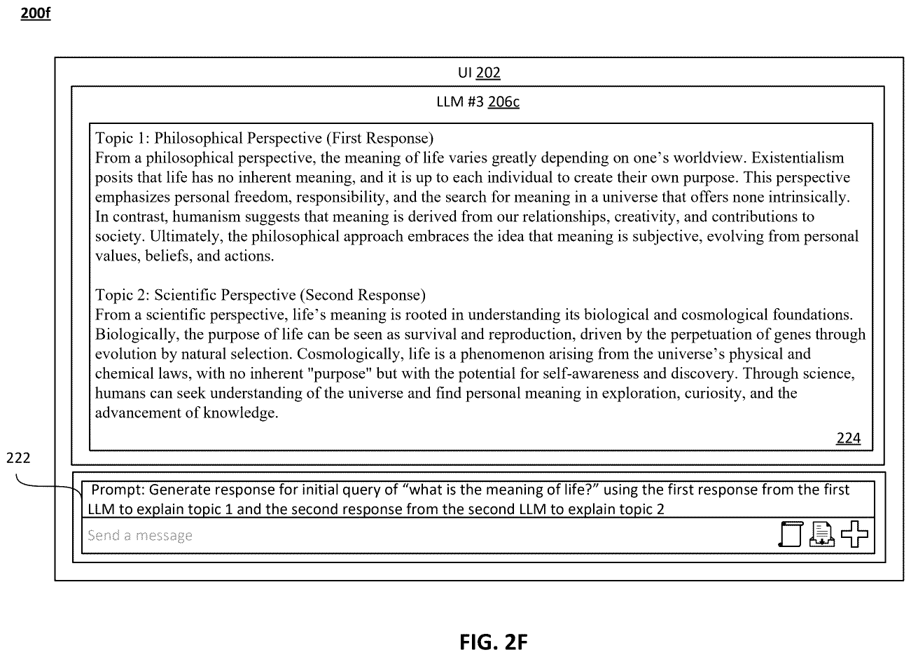

The system 100 may be used to generate and implement a UI for display on the computing device 104. Generally, the topic list generator module 110 is configured to generate a single UI (which will be described in more detail in FIGS. 2A-2F) that facilitates transmitting a prompt across the different LLM service providers 142, 144, 146, unifies responses from the different LLM service providers 142, 144, 146 in a single UI that is displayed on a display of the computing device 104, and generates a topic list based on the responses from the different LLM service providers 142, 144, 146. This provides a way for a user to collect responses from different LLMs, analyze the topics included in each response, and select the topics to be included in a new prompt to improve the original query. In particular, the single UI) may display at least the original query from the user, at least one response from LLMs corresponding to the LLM service providers 142, 144, 146.

In one aspect, the system 100 includes at least a computing device 104, a plurality of LLM service providers 142, 144, 146 each connected to a respective LLM model and a topic list generator module 110. Users of the computing device 104 may communicate with the LLM service providers 142, 144, 146 via the topic list generator module 110. Notably, the LLM of the present embodiment may be implemented on a cloud server, local server, or local devices. As an example, the topic list generator module 110 may be hosted on a cloud server or allocated at a local device.

Each LLM service providers 142, 144, 146 may each connect to a different LLM that generates a different response using a same prompt. These LLM models each use machine learning to understand, process, and generate natural language text in response a query from a user. The LLM models are responsible for the “intelligent” behavior of an application such as answering questions, creating content, summarizing information, translating text, or the like. Accordingly, it is to a user's advantage to view multiple responses from different LLM service providers 142, 144, 146 rather than to rely on just one response from a single LLM service provider. It is noted that the system 100 includes any number of LLM service providers and FIG. 1 only shows the components relevant for the illustrative example of the present disclosure.

In some aspects, the system 100 may include a topic list generator module 110 configured to process a query from a computing device 104 from a user, generate and transmit a prompt based on the query into different LLM service providers 142, 144, 146, and generate a list of topics for the responses from the different LLM service providers 142, 144, 146. In this way, the computing device 104 may be configured to display a single UI with the query and responses from the LLM service providers 142, 144, 146. The computing device 104 may execute a plurality of modules in the topic list generator module 110 that together make up at least an interface to interact with different LLM service providers. The topic list generator module 110 may include at least the following functional modules: a UI generation module 112, a query module 114, a LLM communication module 116, a results analyzer module 118, a topic analyzer MLM module 120, a prompt generator module 122, and a display module 124. Some of these functional modules may be deployed locally on servers, hosted on remote servers, or on local devices.

In some aspects, the topic list generator module 110 may be allocated directly on the computing device 104. In some aspects, the topic list generator module 110 may be hosted on a cloud server. Specifically, the portions of the topic list generator module 110 may be hosted or allocated on different devices. For example, the LLM communication module 116 may be hosted on a cloud system and the results analyzer module 118 and display module 124 may be hosted on a local device.

The computing device 104 may execute a UI generation module 112 to implement a UI for display on the computing device 104 that is configured to receive input from the computing device 104 and combine and provide a topic list from at least one of the LLM service providers 142, 144, 146. In some aspects, the UI generation module 112 generates a single UI (as will described in more detail in FIGS. 2A-G) and layout and components of the UI elements (e.g., menus, buttons, forms, grids, etc.) based on predefined rules, data models, or templates. In some aspects, the UI generation module 112 may also be configured to automatically adjust the UI elements based on the content or data that it needs to display such as adapting a form to input fields or displaying a list of items. In some aspects, the UI generation module 112 may also be configured to adapt the UI to different screen sizes and resolutions by making sure that the UI works well across various devices.

In some aspects, the user interface may be implemented as web-based interface or a desktop application. The user interface allows users to use text queries, prompts, and/or upload files to query LLM service providers 142, 144, 146 for answers to specific questions, to perform particular tasks, or, depending on the natural language processing capabilities of the LLM, to simulate a conversation with the LLM service providers 142, 144, 146 on topics related to the query, prompt, or uploaded files on which the LLM service providers has been trained to answer.

The computing device 104 may also execute a query module 114 to obtain a query from a computing device 104 of a user. Generally, the query module 114 is configured to act as an intermediary layer in LLM-based systems by enhancing a LLM model's ability to understand, interpret, and respond to user queries effectively. Specifically, the query module 114 may be configured to handle and interpret user queries and generate a prompt from the query that is formatted in a way that a LLM from the LLM service providers 142, 144, 146 may process effectively. The primary role of the query module 114 is to bridge the gap between raw user input from the computing device 104 and at least one of the underlying LLM service providers 142, 144, 146. In some aspects, the query module 114 may be equipped with natural language understanding for analyzing and interpreting the query to understand its intent, context, and meaning. This may involve recognizing entities, key phrases, intents, and relationships within the query.

As an example, a user may use the computing device 104 to enter a query for input as a prompt into at least one LLM service provider 142, 144, 146. In some aspects, the query module 114 may prepare the query as a prompt for input into at least one LLM service provider 142, 144, 146 by cleaning and normalizing the text. As an non-limiting example, this may involve: removing unnecessary punctuations, special characters, or stop words; correcting spelling or grammatical errors; or converting different forms of data (e.g., dates, numbers, or units) into a standardized format. By identifying the user's intent behind the query (e.g., asking a question, requesting information, or performing a task), the query module 114 ensure that an appropriate LLM service provider may determine the appropriate type of response or action.

In some aspects, the query module 114 is connected to a query database 132 for storing past queries. For example, the query module 114 may maintain and manage the context of ongoing interactions. In this way, the LLM can understand and respond correctly in multi-turn conversations by retaining information from previous exchanges. In addition, the user may go back and edit the original query easier in the future. In addition, the query database 132 collects and stores feedback on the quality of responses and incorporates this data to refine future query handling, which allows the system to learn and adapt based on user interactions. In some aspects, by recalling a user's query history from the query database 132, the query module 114 may also adjust responses based on user preferences, history, or context. This may involve using a personalized tone, referencing previous interactions, or adapting content to suit the user's knowledge level or interests.

In some aspects, the query module 114 may reformulate and restructure queries to enhance their clarity and ensure that they align with the strengths and weaknesses of particular LLM service providers. This may include simplifying complex sentences or breaking down multi-part questions. In this way, the query module 114 may enhance an LLM service provider's ability to understand and respond accurately to user queries by optimizing and clarifying input.

The computing device 104 may execute a LLM communication module 116 configured to interact with at least two of the LLM service providers 142, 144, 146 by transmitting a prompt generated by the query module 114 for input into at least one of the LLM service providers 142, 144, 146 and to obtain responses from each respective LLM service provider. Generally, the LLM communication module 116 is responsible for managing the interactions between the LLM service providers 142, 144, 146 and modules from the topic list generator module 110. The primary function of the LLM communication module 116 is to handle the exchange of data between the topic list generator module 110 and the LLM service providers 142, 144, 146 to ensure that the inputs and output of the LLM are effectively communicated to the appropriate destinations. This module serves as the interface layer that facilitates communication to enable the LLM service providers 142, 144, 146 to integrate into the system 100.

In some aspects, the LLM communication module 116 is configured to provide an application programming interface (API) that topic list generator module 110 utilizes to interact with the LLM service providers 142, 144, 146. As a non-limiting example, this may include handling API requests and responses from the LLM service providers 142, 144, 146, managing authentication and authorization for secure access, or supporting different API protocols (e.g., REST, WebSocket) to accommodate various integration needs.

In some aspects, the LLM communication module 116 may be configured to keep track of active sessions with users or applications to maintain continuity in multi-turn conversations. This may involve storing session-specific data such as context, chat or session history, or state information or managing multiple concurrent sessions to ensure that each session receives the correct context and responses.

In some aspects, the LLM communication module 116 may be configured to integrate with external systems and databases such as a history/results database 134 or a query database 132. This may involve fetching additional data needed to answer a query or enabling bidirectional communication between the LLM service providers 142, 144, 146 and external systems (e.g., CRM software, knowledge bases, or real-time data feeds). In some aspects, the LLM communication module 116 may collect and manage data related to user preferences or behavior to deliver personalized responses by accessing the history/results database 134.

The computing device 104 may execute a results analyzer module 118 configured to select portions of responses from LLMs into new prompts for input into the LLM service providers 142, 144, 146. Generally, the results analyzer module 118 is responsible for evaluating, refining, and post-processing the outputs generated by the LLMs from the LLM service providers 142, 144, 146. In other words, the results analyzer module 118 ensures that the results produced by the LLMs from the LLM service providers 142, 144, 146 are accurate, relevant, coherent, and aligned with the user's needs.

In some aspects, the results analyzer module 118 is configured to assess the quality of the generated output based on predefined criteria, such as relevant, accuracy, fluency, grammatical correctness, and coherence. In some aspects, the results analyzer module 118 may be configured to check whether the generated responses is relevant to the user's query or the task at hand. In some aspects, the results analyzer module 118 may filter out or flag irrelevant, off-topic, or nonsensical outputs. In some aspects, the user may use the UI to mark portions of the responses from the LLM models as important, not important, or neutral. These marked portions may be stored in the history/results database 134.

The computing device 104 may execute a topic analyzer MLM module 120 configured to generate a list of topics from at least the obtained first selected portion of the first response from the first LLM and the second selected portion of the second response from the second LLM. Specifically, the topic analyzer MLM module 120 may contain a prepared topic analysis MLM prepared to identify topics from responses of the LLMs.

First, the response from the LLMs may be preprocessed by tokenizing the query into individual words or phrases, tagging part-of-speech by identifying nouns, verbs, adjectives, etc. to understand the grammatical structure, or identify specific entities like locations, organizations, dates, or other domain-specific terms. Second, features are extracted to measure how important words are in the response related to a corpus. For example, words or phrases can be converted into dense vector representations for preserving semantic similarity. In addition, the grammatical structure may be analyzed to understand relationships between words. Third, classification or clustering is performed by using algorithms like Latent Dirichlet Allocation (LDA) or Non-Negative Matrix Factorization (NMF) to assign words or phrases in the response to different topics. A supervised learning approach may be used to assign multiple labels (e.g., subject areas) to the response. In addition, similar parts of the response may grouped into clusters that correspond to different subject matters. Fourth, segmentation may be performed to split the response into distinct logical segments based on grammatical dependencies or breaking the response into units based on semantic meaning, identifying possible shifts in context or topics. Fifth, knowledge base integration may include linking keywords and phrase in the response to predefined categories or hierarchies in a knowledge base. For example, domain-specific dictionaries may be used to enhance identification by comparing response terms to dictionaries or databases related to specific subject areas. Post-processing may be used for contextual disambiguation by using surrounding words or phrases to refine the understanding of ambiguous terms and/or for cross-domain classification to determine if identified subject matters fall into distinct domains based on learned domain boundaries.

As an example, a query may ask “What are the benefits of AI in healthcare and finance?” The system 100 may obtain a first response from the first LLM and a second response from the second LLM. The topic analyzer MLM module 120 may preprocess the first and second response to tokenize, remove stop words, and identify named entities (“AI”, “healthcare”, “finance”). The topic analyzer MLM module 120 may then extract features by embedding terms using Bidirectional Encoder Representations from Transformers (BERT), determine context and similarity to known domains. The topic analyzer MLM module 120 may then MLM classification such as outputting two labels—healthcare and finance. The topic analyzer MLM module 120 may then perform segmentation to identify two topic areas by grouping terms related to healthcare and finance separately.

As an example, the topic analyzer MLM module 120 may correspond to a LLM. A LLM is an advanced artificial intelligence system designed to understand and generate human-like text. These models are trained on vast amounts of data, enabling them to comprehend context, recognize patterns, and produce coherent and contextually relevant responses. LLMs are utilized in various applications, including chatbots, content creation, and language translation. Their ability to process and generate natural language makes them powerful tools for enhancing communication and automating tasks that require language understanding. However, the LLM modules must first go through preparing (e.g., training, retraining, distillation, fine-tuning, etc.) to teach each LLM model to perform their respective specific tasks. As a nonlimiting example, the LLM models may incorporate one of the machine learning models listed below.

A transformer is a deep learning architecture used in LLMs. The transformer has an encoder/decoder structure with numerous stacked multi-head attention layers and feed forward network layers. This architecture allows the model to process and generate text effectively, capturing long-range dependencies and contextual information. Transformer are well-suited for tasks like natural language processing, and image classification and generation. Common examples of transformer models are generative pre-trained transformer (GPT) and BERT.

A classification model is a type of machine learning model that is designed to predict the category or class to which a given data point belongs to. The classification model works by analyzing input features and assigning them to one of several predefined labels. These models are trained on labeled data, where the correct category is known, and they learn patterns that allow them to make predictions on new, unseen data. Examples of classification models include at least a regression model used for binary classification, a decision tree used to predict class by splitting data based on feature values, support vector machine (SVM) configured to perform classification by finding the best boundary between classes, and neural networks.

In some examples, the topic analyzer MLM module 120 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by the topic analyzer MLM module 120 may be one of the following: transformer neural network, convolution neural network (CNN), recurrent neural network (RNN), long short-term memory (LSTM) network, gated recurrent unit (GRU) network, autoencoder, generative adversarial network (GAN).

An autoencoder is a type of neural network used for unsupervised learning and dimensionality reduction, and consists of an encoder that compresses input data into a lower-dimensional representation (encoding) and a decoder that reconstructs the original input from the encoding.

For classification tasks such as identifying subject matter in a query or responses from LLMs, an untrained MLM in the topic analyzer MLM module 120 will first analyze data from a training set to “learn” the correct answers and identify the different subject matters in the query. As an example, the training dataset may include at least data that includes a wide range of subjects to ensure the model can generalize well. For example, topics like technology, science, politics, entertainment, sports, health, and finance. The dataset should cover both broad topics and niche subtropics (e.g., “Artificial Intelligence” under “Technology” and “Quantum Computing” under “Science”). Each sample in the dataset should be labeled with its corresponding topic or category. In some aspects, multilabel annotations may be necessary if a response covers multiple topics.

During training of the topic analyzer MLM module 120, the training dataset will comprise data corresponding to a wide variety of topics and subjects that are input through the untrained MLM in the topic analyzer MLM module 120. The results from the untrained MLM are then compared with known data set results using the corresponding labels to identify the topics and/or subject matter. It should be noted that the input to the trained MLM in the topic analyzer MLM module 120 will be data from the training dataset.

For every input training sample from the training dataset, the trained MLM from the topic analyzer MLM module 120 will produce a prediction consisting of values representing a probability that a portion of a response is classified as a particular topic and/or subject matter. The output with the highest probability determines the predicted topic. A class label for each answer may be used to compute a loss (e.g., loss function).

The prepared MLM from the topic analyzer MLM module 120 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks (e.g., predicting brightness levels) or a Cross-Entropy Loss for classification tasks (e.g., detecting specific color changes).

Once the MLM is trained (e.g., inference), the prepared MLM from the topic analyzer MLM module 120 may evaluate the answers for accuracy by comparing them with correct predictions of whether the portions of the response is classified as a correct topic label or not.

During inference, the trained MLM from the topic analyzer MLM module 120 does not re-evaluate or adjust the layers of the neural network based on the results. Instead, the inference applies knowledge from the trained neural network and uses it to infer a result (e.g., correct, partially correct, or incorrect). Accordingly, when a new unknown dataset (e.g., new responses and/or queries) is input through the trained neural network in the topic analyzer MLM module 120, the trained MLM outputs a prediction of what topic portions of the response are classified as based on predictive accuracy of the MLM.

In some aspects, an optimizer such as Adam or SGD may be used to train the models in the topic analyzer MLM module 120. In some aspects, the data may be split into training, validation, and test sets. In these aspects, the models from the topic analyzer MLM module 120 are trained on the training dataset and then validated by the validation sets in order to tune hyperparameters.

In some aspects, the topic analyzer MLM module 120 may utilize a MLM such as LLM to identify the subject matters present in the query. For example, a MLM like BERT used to identify subject matter present in the query involves leveraging the MLM's contextual understanding capabilities to infer the subject or topic embedded in the text. The steps may include understanding the query context. For example, the query can contain keyword or phrases that give away its subject. MLMs may be pretrained to understand relationships between words in context. Next, steps should be taken to identify the subject matter. For example, tokenizers associated with the MLM (E.g., BERTTokenizer) may break the query into tokens. Next, key parts of the response and/or query may be masked. In this way, the MLM may predict missing parts by replacing parts of the response (e.g., nouns, verbs) with the [MASK] token, which can highly the subject. The response is then passed through the MLM to predict the [MASK] token such that the model will return a ranked list of potential tokens that best fit the context. Then, the process involves extracting the most probable predictions for the masked token. These predictions often reflect the subject matter. Beyond the [MASK] prediction, the process may also analyze the context of the entire query and/or response. MLMs like BERT can output embeddings that can be clustered or classified to identify broader subjects.

In some aspects, MLM predictions combined with NLP techniques like clustering or TD-IDF may be used to identify the topic (e.g., subject matter) across multiple queries and/or responses. In some aspects, embeddings can be extracted for comparison with pre-defined topic vectors to identify query and/or response subject matter. In some aspects, the MLM can be fine-tuned on labeled data to classify queries into predefined subjects.

The computing device 104 may execute a prompt generator module 122 configured to generate and transmit a prompt based on the query for input into the first LLM and a second LLM from the LLM service providers 142, 144, 146. In some aspects, the prompt generator module 122 may be configured to obtain a selection of topics from the list of topics to include into the new prompt. In some aspects, the prompt generator module 122 may also be configured to generate the new prompt for input into the third LLM. The new prompt comprising at least one topic from the list of topics using at least the selected portions from the first LLM or the selected portions from the second LLM. As an example, the prompt can be structured as “generate response for the initial query with all topics from the topic list.” As another example, the prompt can be structured as “generate a response for the initial query by using selected text from the response from the first LLM as topic 1 and using selected text from the response from the second LLM as topic 4.” As yet another example, the prompt can be structured as “generate a response for the initial query by using selected text from the response from the first LLM as topic 1, using selected text from the response from the second LLM as topic 4, and exclude topics 2, 3, and 5. As yet another example, the prompt can be structured as “generate a response for the initial query by using selected text from the response from the first LLM as topic 1 and using selected text from the response from the second LLM as topic 4 and combine them with topics 2, 3, and 5.”

In some aspects, the prompt generator module 122 may comprise a natural language processing MLM. In some aspects, the prompt generator module 122 may comprise a MLM prepared for processing physical data models based at least in part on transmitting data in iterations or in a sequence. In some aspects, the prompt generator module 122 may comprise an embeddings generator model.

The computing device 104 may execute a display module 124. The display module 124 may be configured to generate and display the query from the user, at least one response from a LLM service provider, and at least a list of topics for the responses from the LLMs. Generally, the display module 124 is responsible for managing and rendering the visual components of the user interface by handling the presentation of information to the user, ensuring that data and controls are displayed correctly and consistently across the UI.

In some aspects, the display module 124 is configured to render or draw all the elements of the UI, such as windows, buttons, text fields, menus, icons, images, and other components. In some aspects, the display module 124 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 124 may be considered the “view” part of a model-view-controller (MVC) or similar design pattern. It serves as the layer that presents data to the user and receives input to and from the computing device 104.

It should be noted that the identification of topics (e.g., subject matter) in the queries described in the present disclosure are heavily simplified. One skilled in the art will appreciate that the LLMs utilized may have significantly large datasets with highly specific details. For example, the query may include subtle descriptions of different subject matters and topics. This type of analysis would be beyond the capabilities of the human mind because the amount of data to be identified, considered, and processed when detecting and identifying subject matter in a query is unfathomable.

FIGS. 2A-2F are diagrams illustrating a method for generating a new prompt with context from response from LLMs using a topic list according to aspects of the present disclosure. Examples 200a-200g illustrate how responses from LLMs based on an initial query may be used to generate a topic list for including in a new prompt for input into a different LLM model.

As shown in example 200a of FIG. 2A, the UI 202 displays at least a first LLM 204a, a second LLM 206a, an initial query 210 from a user, and a cursor 208. Here, the initial query 210 is to be generated into a prompt for input into the first LLM 204a and the second LLM 206a.

As shown in example 200b of FIG. 2B, the UI 202 displays a first response 204b from the first LLM 204a and a second response 206b from the second LLM 206a. As shown in example 200b, the first response 204b is different than the second response 206b due to the prompt being entered into two different LLMs.

As shown in example 200c of FIG. 2C, the user has selected a first portion 212a (e.g., religious perspectives) from the first response 204b and the user has selected a second portion 212b (e.g., evolutionary perspective) from the second response 206b as sections that from each response that the user is particularly interested in. In this case, the user is interested in these two portions 212a, 212b to input into a third LLM and would like to generate a topic list based on at least those two portions 212a, 212b. In some aspects, a topic list is generated based on all portions of the first response 204b and the second response 206b.

As shown in example 200d of FIG. 2D, a topic list 220 of the responses from the first LLM 204a and the second LLM 206a is generated. In some aspects, the individual topics from the generated topic list 220 may be selectable for inclusion or excluding into the new prompt. As shown here, the selected first portion 212a (e.g., religious perspectives) from the first response 204b and the user has selected a second portion 212b (e.g., evolutionary perspective) are selected from the topic list 220.

As shown in example 200e of FIG. 2E, a user generates a new prompt 222 for input into a third LLM 206c. The new prompt 222 comprising at least one topic from the list of topics using at least the selected portions from the first LLM or the selected portions from the second LLM.

As shown in example 200f of FIG. 2F, the new response 224 from the third LLM 206c is returned with the new prompt 222.

In this way, the user is presented with a improved response to the original query including context from responses from at least a first LLM and a second LLM. Specifically, a user may view and select portions of responses from at least the first LLM and the second LLM and generate a list of topics based off the responses. The user may then view topics from the list of topics and select topics for inclusion in a new prompt for input into the third LLM. It should be noted that the new prompt may also be input back into the first LLM or the second LLM. Furthermore, the UI is configured to combine the responses from both the first LLM and the response from the second LLM with the new prompt in a single UI as well as the actual new prompt.

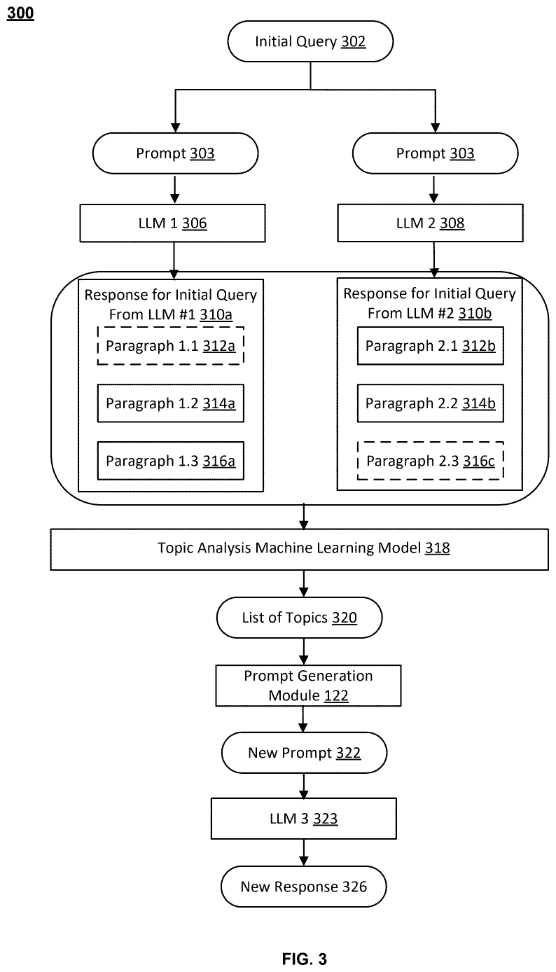

FIG. 3 is a diagram illustrating a method for selecting portions of a response from separate LLM to use as context for generating a new prompt according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory).

The method 300 begins with obtaining an initial query 302 from a user. As an example, referring back to FIG. 2A, the prompt 303 may be “What is the meaning of life.”

The method 300 includes generating and transmitting a prompt 303 to a first LLM 306 and a second LLM 308.

The method 300 includes obtaining a first response 310a from the first LLM including at least a first paragraph 312a, a second paragraph 314a, and a third paragraph 316a and a second response 310b from the second LLM including at least a first paragraph 312b, a second paragraph 314b, and a third paragraph 316c. As an example, referring back to FIG. 2B, the first response 204b includes a first portion (e.g., religious perspectives), a second portion (e.g., philosophical perspectives), and a third portion (e.g., personal meaning) and a second response 206b includes a first portion (e.g., biological perspective), a second portion (e.g., evolutionary perspective), and a third portion (e.g., cosmological perspective).

The method 300 includes obtaining a selection of at least one of the paragraphs in the first response 310a and/or a selection of at least one of the paragraphs in the second response 310b as particularly relevant or interesting sections to expand on. As an example, referring back to FIG. 2C, the user selects a first portion 212a (e.g., religious perspectives) from the first response 204b and a second portion 212b (e.g., evolutionary perspective) from the second response 206b as topics that the user is interested in and would like to include as context in a new prompt.

The method 300 includes using a topic analysis machine learning model 318 (e.g., prepared MLM from the topic analyzer MLM module 120 from FIG. 1) to generate a list of topics 320 from at least the obtained first selected portion of the first response from the first LLM and at least a second selected portion of the second response from the second LLM. As an example, referring back to FIG. 2D, a topic list 220 containing at least a first topic 216 of religious perspectives from the first LLM 204a and a fifth topic 218 of evolutionary perspectives from the second LLM 206a is generated.

The method 300 includes using a prompt generator module 122 to generate a new prompt 322 with context including at least one topic from the list of topics for input into a third LLM 323. In some aspects, the third LLM 323 may correspond to the first LLM 306 or the second LLM 308. In some aspects, the third LLM 323 may be different than the first LLM 306 or the second LLM 308. As an example, referring back to FIG. 2E, the new prompt 222 contains at least a command to “generate a response for initial query of “what is the meaning of life?” using the first response from the first LLM to explain a first topic 216 and the second response from the second LLM to explain a fifth topic 218.

The method 300 includes displaying a new response 326 by entering the new prompt 222 into the third LLM 323. As an example, referring back to FIG. 2F, the new response 224 from the third LLM 206c is displayed along with the new prompt 222.

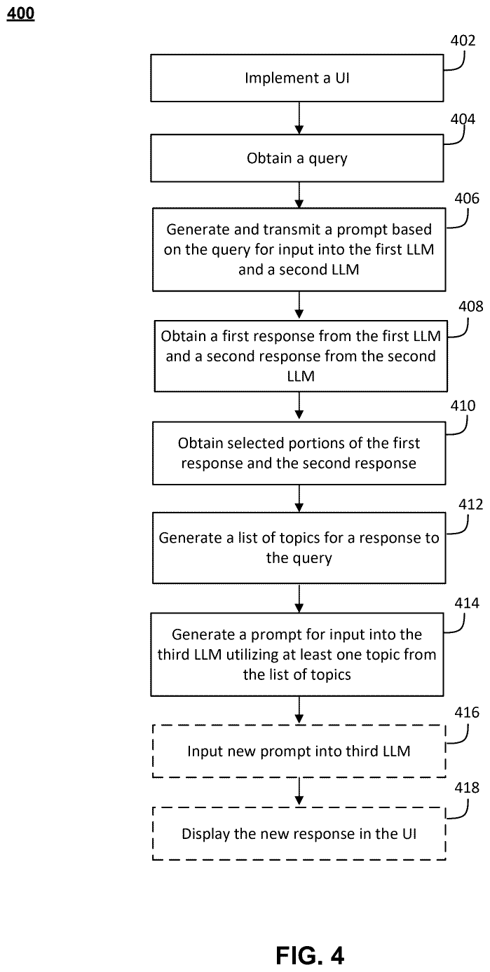

FIG. 4 is a diagram for generating a new prompt with context according to a generated list of topics according to an aspect of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 describes a method for editing a session/chat history of at least one LLM in order to generate a new prompt to personalize subsequent responses.

At 402, the method 400 may include implementing a UI configured to combine and select feedback from at least a first LLM and a second LLM into a new prompt for input into a third LLM. The first LLM being different from the second LLM.

At 404, the method 400 may include obtaining a query from a user from an input portion of the UI.

At 406, the method 400 may include generating and transmitting a prompt based on the query for input into the first LLM and a second LLM.

At 408, the method 400 may include obtaining a first response from the first LLM and a second response from the second LLM. Different LLMs may interpret a prompt or problem in unique ways, leading to varied solutions or responses. This diversity can help uncover new insights or angles that a single LLM might not provide. In addition, comparing responses from two LLMs can help identify inaccuracies or biases in one model's output. If both agree, it's more likely the information is accurate; if they differ, further investigation might be needed. In addition, every LLM is trained on a different dataset and may exhibit biases based on that training. Comparing responses allows you to spot and understand potential biases or gaps in reasoning. Furthermore, one LLM might excel in technical explanations, while another might be better at simplifying concepts. By leveraging the strengths of each, users can obtain a more well-rounded response.

At 410, the method 400 may include obtaining, from the user, at least a first selected portion of the first response from the first LLM and at least a second selected portion of the second response from the second LLM. Allowing users to select portions of a LLM responses to include in a new prompt offers several benefits that enhance interactivity, efficiency, and the overall user experience. First, users can focus the model's attention on the most relevant or valuable part of a previous response. By narrowing the scope of the new prompt, the model can generate more targeted and accurate answers. Second, selecting relevant portions eliminates the need for users to manually retype or summarize the information they want to reference, which streamlines the iterative process to save time and effort. Third, users can guide the conversation more effectively when building on specific insights or ideas from previous responses. This is particularly useful in tasks requiring layered reasoning or iterative refinement, like writing, problem-solving, or coding. By selecting specific portions of the response, users can highlight areas they agree with or want to expand on, effectively collaborating with the model. By selecting only the parts they find useful, users can tailor the LLM's output to suit their individual needs or preferences.

At 412, the method 400 may include generating a list of topics from at least the obtained first selected portion of the first response from the first LLM and the second selected portion of the second response from the second LLM using a trained topic analysis machine learning model (MLM) prepared to identify topics from responses of LLMs. A topic list helps organize key elements of the previous responses by breaking it down into manageable, clearly defined areas. This structure makes it easier to identify what to explore further and ensures no important aspects are overlooked. In this way, users can focus their query on a specific topic, reducing ambiguity and leading to more targeted and relevant responses. For instance, if a response covers multiple subjects, the user can zero in on the one that matters most. In addition, the topic list may reveal aspects that the user hadn't considered, inspiring new questions or ideas for follow-up prompts. By providing a clear breakdown of topics, users can approach their inquiry in stages, asking follow-up questions to deepen understanding or build on prior knowledge. In addition, a topic list ensures that users and the model are aligned on what has been covered and what remains to be explored, which reduces the risk of redundant or off-topic queries.

As an example, if the LLMs generates a response about climate change that covers its causes, impacts, and mitigation strategies, the topic list might look like: 1) causes of climate change, 2) economic impacts, 3) environmental impacts, 4) mitigation strategies, and 5) role of technology. The user can then select a topic like “Mitigation Strategies” to generate a focused follow-up prompt, such as: “Can you elaborate on renewable energy solutions as a mitigation strategy for climate change?”

Optionally, in some aspects, the method 400 may include preparing the topic analysis MLM based on utilizing a text interpretation LLM to identify different subject matter or topics from the responses of the LLMs. A text interpretation LLM identifies different subject matters or topics from LLM responses by analyzing the structure, semantics, and context of the text. It segments the response into logical units, such as sentences or paragraphs, and detects recurring themes, key phrases, or entities. Leveraging natural language processing techniques, the LLM categorizes content based on linguistic patterns, relevance, and domain knowledge. For instance, a response discussing climate change might be parsed into topics like “causes,” “effects,” and “mitigation strategies.” This process enables the LLM to highlight distinct areas of focus, facilitating better organization and targeted follow-up interactions for users.

In some aspects, generating the new prompt for input into the third LLM may include: obtaining a selection of topics from the list of topics to include into the new prompt for the third LLM.

At 414, the method 400 may include generating the new prompt for input into the third LLM, the new prompt comprising at least one topic from the list of topics using at least the selected portions from the first LLM or the selected portions from the second LLM. In some aspects, at least one portion from the first response from the first LLM and the at least one portion from the second response from the second LLM are marked for using as a basis for a respective topics from the list of topics to include into the new prompt for the third LLM.

In some aspects, generating the new prompt for input into the third LLM may include obtaining a selection of particular topics from the list of topics to exclude in the new prompt for the third LLM.

Optionally, at 416, the method 400 may include transmitting the new prompt into the third LLM.

Optionally, at 418, the method 400 may include obtaining and displaying the new response from the third LLM.

In some aspects, the method 400 may include displaying, in the UI, a supplemental UI comprising a menu of text editing functions for editing the query, the first response or the new response. In some aspects, the method 400 may include displaying, in the UI, a first graphical element configured to mark a response as important, not important, or to be deleted.

In some aspects, the method 400 may include displaying, in the UI, a drop down graphical element with options including at least: a first option to edit the query, a second option to save the query, a third option to mark a portion of the first response or the new response as important, a fourth option to mark a portion of the first response or the new response as unimportant, a fifth option to mark a portion of the first response or the new response as to be deleted, or a sixth option to edit the first response from the first LLM or the second response from the second LLM.

Optionally, the method 400 may include: transmitting the new prompt into the first LLM or the second LLM; obtaining at least an updated first response from the first LLM or an updated second response from the second LLM; and displaying the query along with the updated first response from the first LLM in the first portion of the UI or the updated second response from the second LLM in the second portion of the UI.

FIG. 5 is a block diagram illustrating a computer system 20 on which aspects of systems and methods for generating a prompt with context based on generating a topic list for responses from LLMs. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for generating a prompt with context based on a topic list generated from responses from large language models (LLMs), the method comprising:
implementing a UI configured to combine and select feedback from at least a first LLM and a second LLM into a new prompt for input into a third LLM, wherein the first LLM is different from the second LLM;
obtaining a query from a user from an input portion of the UI;
generating and transmitting a prompt based on the query for input into the first LLM and a second LLM;
obtaining a first response from the first LLM and a second response from the second LLM;
obtaining, from the user, at least a first selected portion of the first response from the first LLM and at least a second selected portion of the second response from the second LLM;
generating a list of topics from at least the obtained first selected portion of the first response from the first LLM and the second selected portion of the second response from the second LLM using a trained topic analysis machine learning model (MLM) prepared to identify topics from responses of LLMs; and
generating the new prompt for input into the third LLM, the new prompt comprising at least one topic from the list of topics using at least the selected portions from the first LLM or the selected portions from the second LLM.

2. The method of claim 1, wherein generating the new prompt for input into the third LLM further comprises:
obtaining a selection of topics from the list of topics to include into the new prompt for the third LLM.

3. The method of claim 1, wherein at least one portion from the first response from the first LLM and the at least one portion from the second response from the second LLM are marked for using as a basis for a respective topics from the list of topics to include into the new prompt for the third LLM.

4. The method of claim 1, wherein generating the new prompt for input into the third LLM further comprises:
obtaining a selection of particular topics from the list of topics to exclude in the new prompt for the third LLM.

5. The method of claim 1, further comprising:
transmitting the new prompt into the third LLM; and
obtaining and displaying a new response from the third LLM.

6. The method of claim 1, further comprising:
preparing the topic analysis MLM based on utilizing a text interpretation large language model to identify different subject matter or topics from the responses of the LLMs.

7. The method of claim 1, further comprising:
transmitting the new prompt into the first LLM or the second LLM;
obtaining at least an updated first response from the first LLM or an updated second response from the second LLM; and
displaying the query along with the updated first response from the first LLM in the first portion of the UI or the updated second response from the second LLM in the second portion of the UI.

8. The method of claim 1, further comprising:
displaying, in the UI, a supplemental UI comprising a menu of text editing functions for editing the query, the first response or the new response.

9. The method of claim 1, further comprising:
displaying, in the UI, a first graphical element configured to mark a response as important, not important, or to be deleted.

10. The method of claim 1, further comprising:
displaying, in the UI, a drop down graphical element with options including at least: a first option to edit the query, a second option to save the query, a third option to mark a portion of the first response or the new response as important, a fourth option to mark a portion of the first response or the new response as unimportant, a fifth option to mark a portion of the first response or the new response as to be deleted, or a sixth option to edit the first response from the first LLM or the second response from the second LLM.

11. A system for generating a prompt with context based on a topic list generated from responses from LLMs, the system comprising:
at least one memory; and
at least one hardware processor coupled with the at least one memory and configured, individually or in combination, to:
implement a UI configured to combine and select feedback from at least a first LLM and a second LLM into a new prompt for input into a third LLM, wherein the first LLM is different from the second LLM;
obtain a query from a user from an input portion of the UI;
generate and transmit a prompt based on the query for input into the first LLM and a second LLM;
obtain a first response from the first LLM and a second response from the second LLM;
obtain, from the user, at least a first selected portion of the first response from the first LLM and at least a second selected portion of the second response from the second LLM;
generate a list of topics from at least the obtained first selected portion of the first response from the first LLM and the second selected portion of the second response from the second LLM using a trained topic analysis machine learning model (MLM) prepared to identify topics from responses of LLMs; and
generate the new prompt for input into the third LLM, the new prompt comprising at least one topic from the list of topics using at least the selected portions from the first LLM or the selected portions from the second LLM.

12. The system of claim 11, wherein generating the new prompt for input into the third LLM further comprises:
obtaining a selection of topics from the list of topics to include into the new prompt for the third LLM.

13. The system of claim 11, wherein at least one portion from the first response from the first LLM and the at least one portion from the second response from the second LLM are marked for using as a basis for a respective topics from the list of topics to include into the new prompt for the third LLM.

14. The system of claim 11, wherein generating the new prompt for input into the third LLM further comprises:
obtaining a selection of particular topics from the list of topics to exclude in the new prompt for the third LLM.

15. The system of claim 11, wherein the at least one hardware processor coupled with the at least one memory and is further configured, individually or in combination, to:
transmit the new prompt into the third LLM; and
obtain and display a new response from the third LLM.

16. The system of claim 11, wherein the at least one hardware processor coupled with the at least one memory and is further configured, individually or in combination, to:
prepare the topic analysis MLM based on utilizing a text interpretation large language model to identify different subject matter or topics from the responses of the LLMs.

17. The system of claim 11, wherein the at least one hardware processor coupled with the at least one memory and is further configured, individually or in combination, to:
transmit the new prompt into the first LLM or the second LLM;
obtain at least an updated first response from the first LLM or an updated second response from the second LLM; and
display the query along with the updated first response from the first LLM in the first portion of the UI and the updated second response from the second LLM in the second portion of the UI.

18. The system of claim 11, wherein the at least one hardware processor coupled with the at least one memory and is further configured, individually or in combination, to:
display, in the UI, a supplemental UI comprising a menu of text editing functions for editing the query, the first response or the new response.

19. The system of claim 11, wherein the at least one hardware processor coupled with the at least one memory and is further configured, individually or in combination, to:
display, in the UI, a first graphical element configured to mark a response as important, not important, or to be deleted.

20. A non-transitory computer readable medium storing thereon computer executable instructions for generating a prompt with context based on a topic list generated from responses from LLMs, including instructions for:
implementing a UI configured to combine and select feedback from at least a first LLM and a second LLM into a new prompt for input into a third LLM, wherein the first LLM is different from the second LLM;
obtaining a query from a user from an input portion of the UI;
generating and transmitting a prompt based on the query for input into the first LLM and a second LLM;
obtaining a first response from the first LLM and a second response from the second LLM;
obtaining, from the user, at least a first selected portion of the first response from the first LLM and at least a second selected portion of the second response from the second LLM;
generating a list of topics from at least the obtained first selected portion of the first response from the first LLM and the second selected portion of the second response from the second LLM using a trained topic analysis machine learning model (MLM) prepared to identify topics from responses of LLMs; and
generating the new prompt for input into the third LLM, the new prompt comprising at least one topic from the list of topics using at least the selected portions from the first LLM or the selected portions from the second LLM.
